(19) United States
(12) Patent Application Publication
(10) Pub. No.: US 2026/0290001 A1
(43) Pub. Date: Sep. 24, 2026

(54) GENERATING REPRESENTATIONS OF ENVIRONMENTS

(71) Applicant: QUALCOMM Incorporated, San Diego, CA (US)

(72) Inventors: David Oskar Peter FORSLUND, Linköping (SE); Anisse TALEB, Nykil (SE); Meysam SADEGHIGOOGHARI, Linköping (SE); Yiming HU, Stockholm (SE)

(21) Appl. No.: 19/088,845

(22) Filed: Mar. 24, 2025

(51) Int. Cl. G06V 10/98; G06V 10/764; G06V 10/77; G06V 10/82; G06V 20/58

(52) U.S. Cl. CPC G06V 10/993; G06V 10/764; G06V 10/7715; G06V 20/58; G06V 10/82

(57) ABSTRACT

Systems and techniques are described herein for generating a representation of an environment. For instance, a method for generating a representation of an environment is provided. The method may include processing a plurality of images of the environment to generate a respective plurality of image-feature tensors; processing the plurality of image-feature tensors to generate a respective plurality of image-degradation tensors, wherein the plurality of image-degradation tensors are based on respective degradation levels of the plurality of images; and generating the representation of the environment based on the plurality of image-feature tensors and the plurality of image-degradation tensors.

### TECHNICAL FIELD

The present disclosure generally relates generating representations of environments. For example, aspects of the present disclosure include systems and techniques for generating representations of environments using image-degradation awareness.

### BACKGROUND

Many devices include one or more cameras. For example, a vehicle may include cameras facing one or more directions away from the vehicle. A camera can capture images using an image sensor of the camera, which can include an array of photodetectors. Some vehicles can analyze image data captured by cameras of the vehicle to generate a representation of an environment of the vehicle.

Driving systems of vehicles (e.g., autonomous, semi-autonomous, or assisted driving systems, such as an advanced driver assistance system (ADAS)) may perform various tasks using a representation of an environment. For example, a driving system may detect objects in the environment and determine what area is drivable and what objects (e.g., road users, other vehicles, bikes, pedestrian, etc.) are present and/or are moving in the environment around the vehicle. The driving system then makes decisions about how to move (e.g., slower, faster, stop, changing lanes, turning, a path to take, etc.) based on object detections, such as drivable areas and/or detected objects.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for generating a representation of an environment. According to at least one example, a method is provided for generating a representation of an environment. The method includes: processing a plurality of images of the environment to generate a respective plurality of image-feature tensors; processing the plurality of image-feature tensors to generate a respective plurality of image-degradation tensors, wherein the plurality of image-degradation tensors are based on respective degradation levels of the plurality of images; and generating the representation of the environment based on the plurality of image-feature tensors and the plurality of image-degradation tensors.

In another example, an apparatus for generating a representation of an environment is provided that includes at least one memory and at least one processor (e.g., configured in circuitry) coupled to the at least one memory. The at least one processor configured to: process a plurality of images of the environment to generate a respective plurality of image-feature tensors; process the plurality of image-feature tensors to generate a respective plurality of image-degradation tensors, wherein the plurality of image-degradation tensors are based on respective degradation levels of the plurality of images; and generate the representation of the environment based on the plurality of image-feature tensors and the plurality of image-degradation tensors.

In another example, a non-transitory computer-readable medium is provided that has stored thereon instructions that, when executed by one or more processors, cause the one or more processors to: process a plurality of images of the environment to generate a respective plurality of image-feature tensors; process the plurality of image-feature tensors to generate a respective plurality of image-degradation tensors, wherein the plurality of image-degradation tensors are based on respective degradation levels of the plurality of images; and generate the representation of the environment based on the plurality of image-feature tensors and the plurality of image-degradation tensors.

In another example, an apparatus for generating a representation of an environment is provided. The apparatus includes: means for processing a plurality of images of the environment to generate a respective plurality of image-feature tensors; means for processing the plurality of image-feature tensors to generate a respective plurality of image-degradation tensors, wherein the plurality of image-degradation tensors are based on respective degradation levels of the plurality of images; and means for generating the representation of the environment based on the plurality of image-feature tensors and the plurality of image-degradation tensors.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a birds-eye view diagram illustrating a vehicle along with images captured using sensors coupled to the vehicle, in accordance with some examples;

FIG. 2A includes an example image captured by a camera on a vehicle;

FIG. 2B includes another example image captured by a camera on a vehicle;

FIG. 2C includes yet another example image captured by a camera on a vehicle;

FIG. 3 is a diagram illustrating an example system for generating a representation (e.g., a BEV feature map) of an environment (e.g., of a vehicle) based on images of the environment, according to various aspects of the present disclosure;

FIG. 4 is a diagram illustrating an example system for generating a representation (e.g., a BEV feature map) of an environment (e.g., of a vehicle) based on image features and image-degradation features, according to various aspects of the present disclosure;

FIG. 5 includes an example image divided into regions to provide context for a description of generating a representation (e.g., a BEV feature map) of an environment (e.g., of a vehicle) based on images of the environment, according to various aspects of the present disclosure;

FIG. 6 is a diagram illustrating a process of processing depth data based on degradation type, according to various aspects of the present disclosure;

FIG. 7 is a diagram illustrating an example system for generating a representation (e.g., a BEV feature map) of an environment (e.g., of a vehicle) based on image features and image-degradation features, according to various aspects of the present disclosure;

FIG. 8 is a diagram illustrating an example system for generating a representation (e.g., a BEV feature map) of an environment (e.g., of a vehicle) based on image features and image-degradation features, according to various aspects of the present disclosure;

FIG. 9 includes representations of various resolutions to provide context for a description of operating and/or training various elements of the system of FIG. 3, according to various aspects of the present disclosure;

FIG. 10 includes an example segmented image and elements of the system of FIG. 3 to provide context for a description training encoders of the system of FIG. 3 using segmented images, according to various aspects of the present disclosure;

FIG. 11 includes elements of the system of FIG. 3 to provide context for a description of training a representation generator of the system of FIG. 3, according to various aspects of the present disclosure;

FIG. 12 is a block diagram of an example system for perception, according to various aspects of the present disclosure;

FIG. 13 is a block diagram of an example system for perception, according to various aspects of the present disclosure;

FIG. 14 is a flow diagram illustrating an example process for generating a representation of an environment, in accordance with aspects of the present disclosure;

FIG. 15 is a block diagram illustrating an example of a deep learning neural network that can be used to perform various tasks, according to some aspects of the disclosed technology;

FIG. 16 is a block diagram illustrating an example of a convolutional neural network (CNN), according to various aspects of the present disclosure; and

FIG. 17 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

A camera is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during capture of one or more image frames, such as ISO, exposure time, aperture size, f/stop, shutter speed, focus, and gain. For example, settings or parameters can be applied to an image sensor for capturing the one or more image frames. Other camera settings can configure post-processing of one or more image frames, such as alterations to contrast, brightness, saturation, sharpness, levels, curves, or colors. For example, settings or parameters can be applied to a processor (e.g., an image signal processor or ISP) for processing the one or more image frames captured by the image sensor.

As mentioned above, some vehicles can analyze image data captured by cameras of the vehicle to generate a representation of an environment of the vehicle. Driving systems of vehicles (e.g., autonomous, semi-autonomous, or assisted driving systems, such as an advanced driver assistance system (ADAS)) may perform various tasks using a representation of an environment.

For example, a driving system may detect, recognize, classify, and/or track an object within an environment of a vehicle based on representations of the environment. For instance, by detecting and/or recognizing an object in multiple representations of the environment, the driving system can track movement of the object over time.

Further, a driving system may detect objects in the environment (e.g., other vehicles, other road users, lane lanes, traffic signs, etc.) and determine what area is drivable and what objects (e.g., road users, other vehicles, bikes, pedestrian, etc.) are present and/or are moving in the environment around the vehicle. The driving system then makes decisions about how to move (e.g., slower, faster, stop, changing lanes, turning, a path to take, etc.) based on object detections, such as drivable areas and/or detected objects.

Driving systems (e.g., autonomous, semi-autonomous, and/or assisted driving systems, such as an advanced driver assistance systems (ADAS)) of vehicles may assist a driver of a vehicle. Such driving systems may operate at various levels of autonomy. For example, autonomy level 0 requires full control from the driver as the vehicle has no autonomous driving system, and autonomy level 1 involves basic assistance features, such as cruise control, in which case the driver of the vehicle is in full control of the vehicle. Autonomy level 2 refers to semi-autonomous driving, where the vehicle can perform functions, such as drive in a straight path, stay in a particular lane, control the distance from other vehicles in front of the vehicle, or other functions. Autonomy levels 3, 4, and 5 include much more autonomy. For example, autonomy level 3 refers to an on-board autonomous driving system that can take over all driving functions in certain situations, where the driver remains ready to take over at any time if needed. Autonomy level 4 refers to a fully autonomous experience without requiring a user's help, even in complicated driving situations (e.g., on highways and in heavy city traffic). With autonomy level 4, a person may still remain in the driver's seat behind the steering wheel. Vehicles operating at autonomy level 4 can communicate and inform other vehicles about upcoming maneuvers (e.g., a vehicle is changing lanes, making a turn, stopping, etc.). Autonomy level 5 vehicles fully autonomous, self-driving vehicles that operate autonomously in all conditions. A human operator is not needed for the vehicle to take any action.

Surround-camera configurations may be used in ADAS applications. For example, a vehicle including an ADAS may include cameras on multiple sides of the vehicle capturing images of the environment of the vehicle in multiple respective directions away from the vehicle.

In camera-based vision systems, vision functions, such as vehicle and lane detection, can be affected by image degradations (e.g., blockages, sun glare etc.). In conventional bird's-eye-view (BEV) approaches to multi-camera detection, features are drawn from all images and all images contribute to a final function prediction. However, if part of one camera is blocked or degraded, the corresponding features are still aggregated in the BEV space, producing a poor representation of the environment which by extension may lead to lower-quality detections of objects.

Systems, apparatuses, methods (also referred to as processes), and computer-readable media (collectively referred to herein as “systems and techniques”) are described herein for generating representations of environments. For example, the systems and techniques described herein may incorporate image degradation into Bird's-Eye-View (BEV) feature computation.

For example, the systems and techniques may use one or more encoder(s) to extract image features (e.g., image-feature tensors) from each image of a plurality of images captured by a plurality of respective cameras (e.g., cameras arranged in a surround-camera configuration). The systems and techniques may weight the image features based on their respective levels of degradation. This weighting mechanism may be implemented in one of several different techniques described herein. In some aspects, the actual parameters may steer the weighting learned from data either directly or indirectly during the training of BEV features, potentially using task-specific heads.

For example, the systems and techniques may determine an image-degradation tensor for each image and/or for each camera. The systems and techniques may derive such image-degradation tensors from the same image encoder used to generate the image features or from a separate network that is independent of the one used for BEV generation. Each set of image features may correspond to a respective camera. In some instances, an image-degradation tensor may be used for all images from a camera, or to all images from a camera for a period of time. In other instances, an image-feature tensor may be determined for each image independently. In any case, the image features may be weighted according to a corresponding degradation level before being projected to the BEV representation.

In some aspects, the systems and techniques may be degradation-type agnostic. For example, the systems and techniques may not consider the type or cause of degradation. In other aspects, the systems and techniques may be type sensitive. For example, the systems and techniques may take into account the specific source or cause of the degradation.

By weighting image features based on image-degradation tensors, the systems and techniques may improve representations of scenes (e.g., feature-based 3D and/or BEV representations of scenes) generated based on the image features. For example, in a case that a region of images from one camera of a plurality of cameras is degraded, features from other cameras of the plurality of cameras may be emphasized and features from the degraded camera region may be subdued. Thus, the representational power of the BEV features is enhanced by the image-degradation awareness. The systems and techniques may improve the performance of downstream tasks (such as vehicle detection, pedestrian detection, lane detection, motion planning and control, such as steering, braking, accelerating, etc., control of headlights, etc.) by improving the BEV features. By introducing uncertainty and degradation awareness into BEV features, the systems and techniques may enhance the safety of ADAS by improving performance of any BEV-based downstream functions in conditions of image degradation.

Surround-view cameras may be mounted in low and/or exposed positions on vehicles which may expose such cameras to dust, water, and/or mud. Thus, image degradation is common in surround-view cameras. The systems and techniques may allow for better use of degraded image data which may improve the performance of downstream functions. For example, improved performance using degraded images may increase availability of ADAS features.

The systems and techniques may be independent of perspective view to BEV projection. Hence the systems and techniques may apply to any approach for feature lifting to BEV-space. As such the systems and techniques may be used as a plug and play solution in any multi-view detector approach using a BEV representation. The systems and techniques enable efficient usage of multi-view nature of a sensor rig. The systems and techniques may downgrade the impacted regions of affected views. The systems and techniques may enable improved performance of any multi-view detector (e.g., to detect vehicles, pedestrians, lanes). The systems and techniques may learn to down-weight degraded features from data and functionality to leverage degradation of a multi-view detector does thus not need to be hand coded. Various aspects of the application will be described with respect to the figures below.

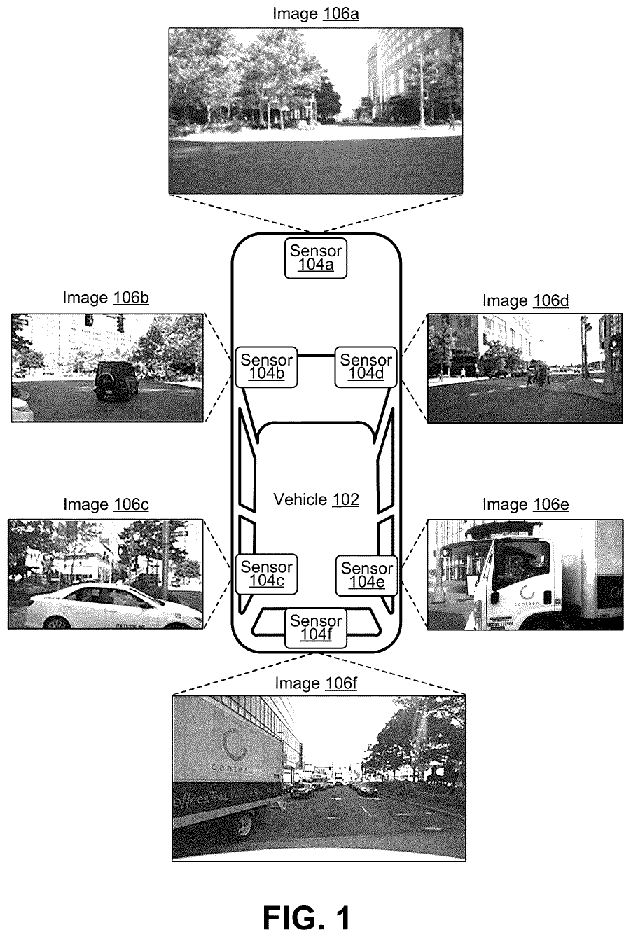

FIG. 1 illustrates a vehicle 102 that includes multiple sensors (e.g., sensors 104a to 104f) that are coupled to vehicle 102 at different positions (e.g., a surround-camera configuration). Sensors 104a to 104f (e.g., image sensors such as cameras) may capture images 106a to 106f of an environment of vehicle 102 from different perspectives. For example, a front-facing sensor 104a can capture images (including image 106a) of the environment in front of the vehicle. As another example, a rear-facing sensor 104F can capture images (including image 106f) of the environment behind the vehicle. The systems and techniques may be implemented in systems (e.g., vehicles) including surround cameras. Additionally or alternatively, the systems and techniques may be implemented in systems including two or more cameras facing substantially the same direction (e.g., with different optics, such as to cover long and short range).

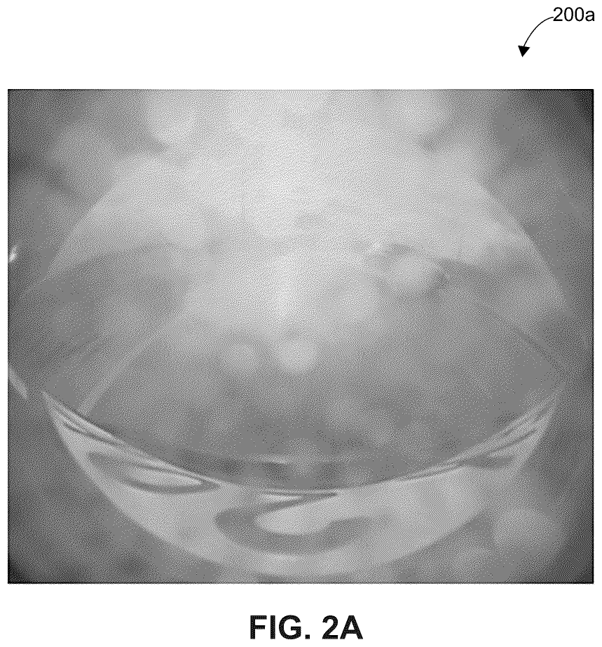

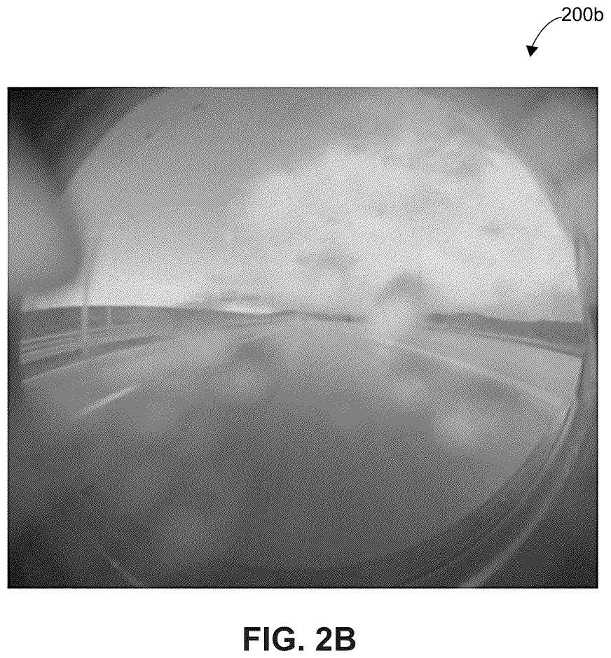

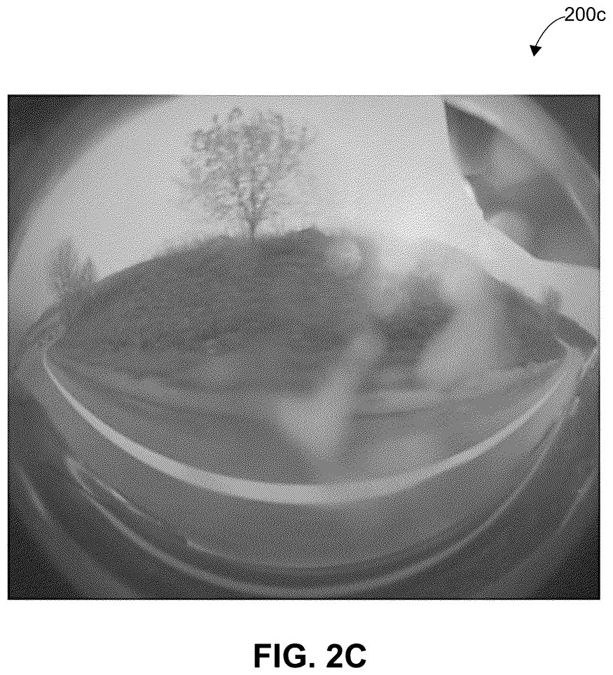

FIG. 2A includes an example image 200a captured by a camera on a vehicle. As illustrated, image 200a is degraded. For example, the image 200a can be degraded based on dirt or water on a camera that captured image 200a and/or glare from the sun.

FIG. 2B includes an example image 200b captured by a camera on a vehicle. Image 200b is degraded. For example, the image 200b can be degraded based on water on a camera that captured image 200b.

FIG. 2C includes an example image 200c captured by a camera on a vehicle. Image 200c is degraded (e.g., based on water on a camera that captured image 200a and/or glare from the sun).

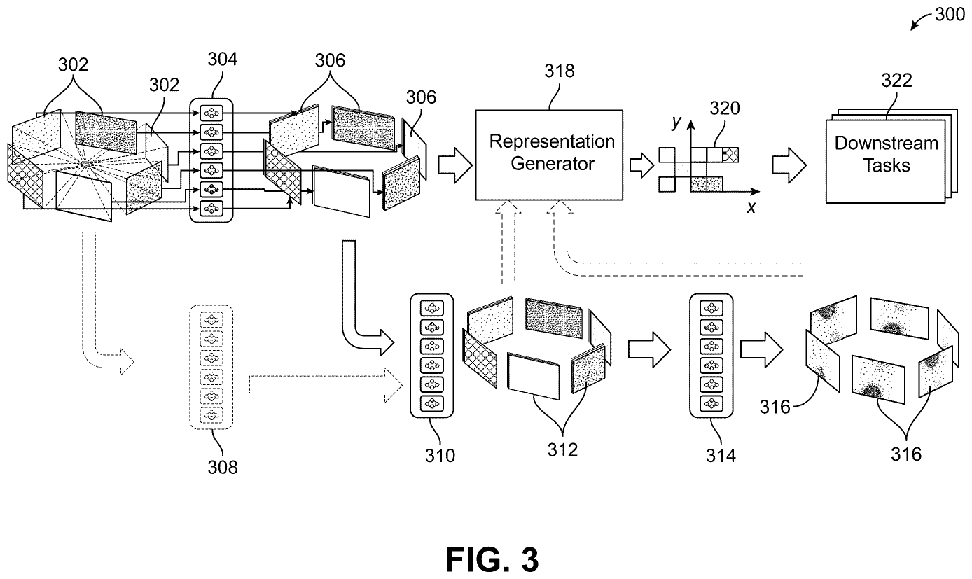

FIG. 3 is a diagram illustrating an example system 300 for generating a representation (e.g., a BEV feature map) of an environment (e.g., of a vehicle) based on images 302 of the environment, according to various aspects of the present disclosure. In general, feature encoder(s) 304 may generate image-feature tensors 306 based on images 302. Additionally, degradation encoder(s) 310 may generate image-degradation tensors 312 based on image-feature tensors 306. In some aspects, severity encoder(s) 314 may generate image-degradation-severity features 316 based on image-degradation tensors 312. Representation generator 318 may generate features 320 based on image-feature tensors 306 and image-degradation tensors 312 and/or image-degradation-severity features 316.

Feature encoder(s) 304 may generate image-feature tensors 306 based on images 302. Images 302 may be, or may include, a plurality of images of an environment. Images 302 may include a plurality of images captured from a respective plurality of cameras. The cameras may be facing different directions such that the images 302 may represent the environment from different perspectives. Additionally or alternatively, two or more of the cameras may face the same, or substantially the same, direction. Images 302 may be captured by cameras of a vehicle (e.g., in a surround-camera configuration). For example, images 106a to image 106f of FIG. 1, capture by sensor 104a to sensor 104f, may be examples of images 302.

Feature encoder(s) 304 may be, or may include, one or more machine-learning models (e.g., one or more convolutional neural networks (CNNs)) trained to generate image features based on images. Feature encoder(s) 304 may include any number of encoders (e.g., one encoder for each camera that captures images 302). Alternatively, feature encoder(s) 304 may include fewer encoders than the number of images 302. In such cases, the fewer number of feature encoder(s) 304 may encode multiple ones of images 302 in turn.

Image-feature tensors 306 may be, or may include, image features based on images 302. Image-feature tensors 306 may be a feature-based representation of images 302 based on feature encoder(s) 304.

In some aspects, feature encoder(s) 308 may encode images 302 to generate image features (not illustrated in FIG. 3). Feature encoder(s) 308 may be the same as, may be substantially similar to, and/or may perform the same, or substantially the same, operations as feature encoder(s) 304. In some aspects, feature encoder(s) 308 may be trained separately from feature encoder(s) 304 using single views on degraded images as a means of specializing the for the concerns of the BEV backbone and the image-degradation backbones. For example, feature encoder(s) 308 may be trained with degradation encoder(s) 310, severity encoder(s) 314, and/or representation generator 318 (e.g., through an end-to-end training process).

Feature encoder(s) 308 may provide the image features generated by feature encoder(s) 308 to degradation encoder(s) 310. In other aspects, feature encoder(s) 308 may be omitted and system 300 may provide image-feature tensors 306 to degradation encoder(s) 310. Feature encoder(s) 308 is illustrated in FIG. 3 using dashed lines to indicate that feature encoder(s) 308 is optional in system 300.

Degradation encoder(s) 310 may generate image-degradation tensors 312 based on image-feature tensors 306 (or in some cases, based on feature encoder(s) 308). Degradation encoder(s) 310 may be, or may include, one or more machine-learning models trained to generate image features related to image degradation (e.g., image-degradation features).

Image-degradation tensors 312 may be, or may include, image features based on degradation of images 302. Image-degradation tensors 312 may be a feature-based representation of images 302 based on degradations of images 302.

In some aspects, severity encoder(s) 314 may process image-degradation tensors 312 to generate image-degradation-severity features 316. Severity encoder(s) 314 may be, or may include, one or more machine-learning models trained to generate image-degradation-severity features based on image-degradation features.

Image-degradation-severity features 316 may be, or may include, image-degradation severity segmentation maps that may indicate a magnitude of degradation in different regions of corresponding images at various resolutions. Image-degradation-severity features 316 may be, or may include, values having various resolutions of data. For example, image-degradation-severity features 316 may be, or may include, a dense output, a single scalar value, or anything in between. For instance, the supervised severity levels can be represented in a range of different resolutions. For example, a dense resolution may include a pixel-level semantic segmentation. At the other extreme, a sparse resolution may include a scalar value representing a degradation of an entire image.

In some aspects, representation generator 318 may process image-feature tensors 306 and image-degradation tensors 312 to generate features 320. In other aspects, representation generator 318 may process image-feature tensors 306 and image-degradation-severity features 316 to generate features 320. In still other aspects, representation generator 318 may process image-feature tensors 306, image-degradation tensors 312, and image-degradation-severity features 316 to generate features 320.

Representation generator 318 may be, or may include, one or more machine-learning models trained to generate a representation of a scene based on image feature and degradation features. For example, representation generator 318 may be trained to generate a BEV feature map based on image features and image-degradation features.

For example, representation generator 318 may project points of image-feature tensors 306 into a 3D space (or a 2D BEV space). Further, representation generator 318 may generate a representation of the environment based on the projected points. In some aspects, representation generator 318 may flatten a 3D feature representation of a scene into a 2D BEV feature space. As another example, representation generator 318 may pull points from image-feature tensors 306 to provide values for a 3D representation of an environment (or a 2D BEV representation of the environment).

Features 320 may be, or may include, a 3D feature representation of the environment or a BEV feature representation of the environment. Points of features 320 may correspond to points in the environment. Features 320 may include features that may be used by downstream tasks 322 for various tasks.

Downstream tasks 322 may use features 320 to perform various tasks, such as object detection (e.g., lane detection, traffic-sign detection, vehicle detection, person detection, etc.) and generating a visual representation of the environment. For example, an object detector may detect objects in the environment based on features 320. As another example, a decoder and rasterizer may generate images representing the scene based on features 320.

FIG. 3 includes various representations of images, encoders, features, feature maps, semantic feature maps, etc. The representations are for illustrative purposes and do not limit any specific aspect of the elements of system 300 that they represent. For example, images 302 may include any number of images captured at any number of angles relative to one another. Feature encoder(s) 304 may include any number of individual encoders, each with any number of layers. Features 320 may include a feature map with any number of points. Additionally or alternatively, features 320 may be tied to a dense grid (e.g., cartesian, polar, etc.) or sparse in any configuration suitable for the downstream tasks.

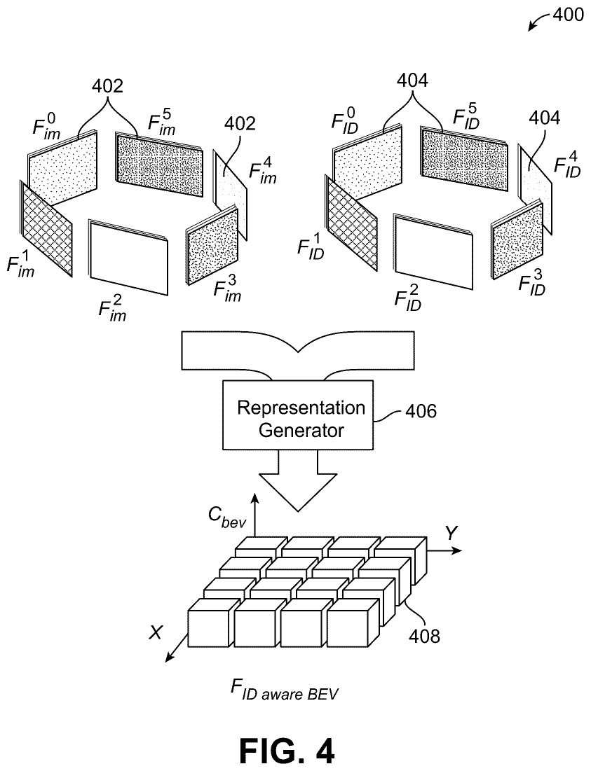

FIG. 4 is a diagram illustrating an example system 400 for generating a representation (e.g., a BEV feature map) of an environment (e.g., of a vehicle) based on image features and image-degradation features, according to various aspects of the present disclosure. For example, a representation generator 406 may generate features 408 based on image-feature tensors 402 and image-degradation tensors 404.

Image-feature tensors 402 may be an example of image-feature tensors 306 of FIG. 3. Image-feature tensors 402 may include 2D image features from multiple cameras. Image-feature tensors 402 may be represented as:

$${F}_{im}^{c} ∈ {R}^{W \times H \times {C}_{i}}$$

where c represents cameras {0, 1, . . . , n}, n represents a number of images from which images are obtained, Cᵢ represents a number of channels in the feature tensor, W represents a width of the images, and H represents a height of the images. The feature tensor can have any number of dimensions (e.g., 32, 48, or another number).

Image-degradation tensors 404 may be an example of image-degradation tensors 312 of FIG. 3 and/or image-degradation-severity features 316 of FIG. 3. Image-degradation tensors 404 may be, or may include, 2D image-degradation features corresponding to images captured by camera c. According to some aspects, image-degradation tensors 404 may be represented as:

$${F}_{ID}^{c} ∈ {R}^{W \times H \times {C}_{d}}$$

where c represents cameras {0, 1, . . . , n}, n represents a number of images from which images are obtained, C_{d} represents a number of channels in the image-degradation tensors, W represents a width of the images, and H represents a height of the images.

In some aspects, image-degradation channels may refer to different types of image degradation as well. For example, each channels of image-degradation tensors 404 may represent a different class of image degradation.

Width W and height H for image-feature tensors 402 and image-degradation tensors 404 are treated as equal for illustrative purposes. In practice, the width W and height H of image-feature tensors 402 and image-degradation tensors 404 are not equal, system 400 may interpolate (e.g., using bilinear interpolation) to cause image-feature tensors 402 and image-degradation tensors 404 to have the same width W and height H.

Representation generator 406 may be an example of representation generator 318 of FIG. 3. Representation generator 406 may generate features 408 based on image-feature tensors 402 and image-degradation tensors 404.

Features 408 may be an example of features 320 of FIG. 3. For example, features 408 may be a BEV feature map. Features 408 may be represented as:

$${F}_{ID aware BEV} ∈ {R}^{X \times Y \times {C}_{bev}}$$

where X represents a width of the 2D BEV space, Y represents a height of the 2D BEV space, and C_{bev} represents a number of channels.

In some aspects, representation generator 406 may combine image-feature tensors 402 with image-degradation tensors 404 through a process of weighted multiplication. For example, representation generator 406 may determine divide image-feature tensors 402 and image-degradation tensors 404 into a number of regions. The number of regions may be the same as the number of cells in the tensor (e.g., W*H). In many cases, feature maps are designed to have dimensions of W*H such that W*H corresponds to the desired number of regions. Representation generator 406 may determine a weight (e.g., a value between 0 and 1) for degradations of each region of image-feature tensors 402 based on the corresponding regions of image-degradation tensors 404. Representation generator 406 may multiply the regions of image-feature tensors 402 by the weights determined based on image-degradation tensors 404 to generate features 408.

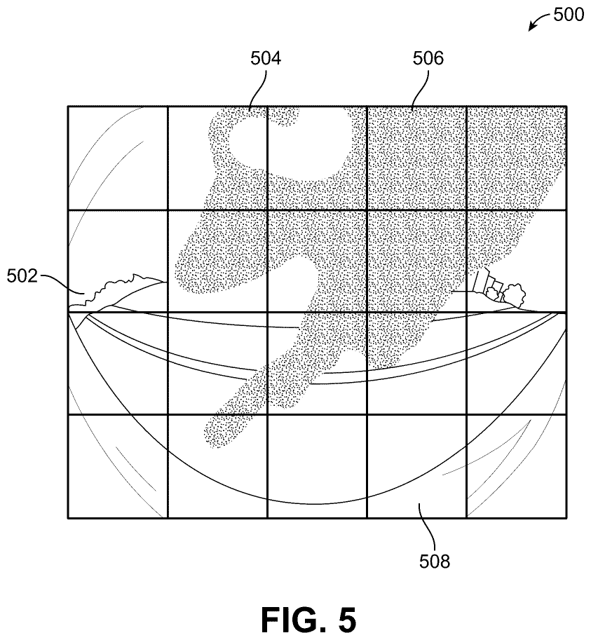

FIG. 5 includes an example image divided into regions to provide context for a description of generating a representation (e.g., a BEV feature map) of an environment (e.g., of a vehicle) based on images of the environment, according to various aspects of the present disclosure. For example, image 500 may be an example image on which one of image-feature tensors 402 is based. The one of image-feature tensors 402 may include regions corresponding to the regions of image 500. Similarly, the one of image-feature tensors 402 may be encoded (e.g., by degradation encoder(s) 310) to generate one of image-degradation tensors 404. The one of image-degradation tensors 404 may include regions corresponding to the regions of image 500.

Representation generator 406 may determine weights for each of the regions of the one of image-feature tensors 402 based on the corresponding regions of the one of image-degradation tensors 404. For example, representation generator 406 may determine an ID type/channel weighting based on the one of image-degradation tensors 404. For instance representation generator 406 may generate a learnable weight matrix represented as:

$${W}_{ID} ∈ {R}^{1 \times 1 \times {C}_{d}}$$

where C_{d} represents a number of channels in the image-degradation tensors.

As an example, based on the one of image-degradation tensors 404 that corresponds to image 500, representation generator 406 may determine that region 502 has a weight of 1 (e.g., no degradation), region 504 has a weight of 0.4 (e.g., 60% degradation), region 506 has a weight of 0 (e.g., 100% degradation), and 508 has a weight of 0.95 (e.g., 5% degradation).

Representation generator 406 may weight degradation channels differently based on W_{ID}. Further, representation generator 406 may compute weighted image features, which may be represented as:

$${F}_{WID}^{C} = {F}_{ID}^{C} ⊙ {W}_{ID} ∈ {R}^{W \times H \times 1}$$

where c represents cameras {0, 1, . . . , n}, n represents a number of images from which images are obtained, W represents a width of the images, and H represents a height of the images.

In some aspects, representation generator 406 may determine W_{ID} as an identity matrix. For example, representation generator 406 may weight each image plane feature by the probability of degradation of that image area. For instance

$${F}_{ID}^{c}$$

could be defined as the probability of degradation of that image area.

In other aspects, representation generator 406 may determine W_{ID} is a learnable weight matrix. This allows the model to learn the importance of each type of degradation and/or adaptively aggregate the various ID features corresponding to the same image region.

In some aspects, image-degradation tensors 404 may be based at least in part on degradation types. For example, severity encoder(s) 314 may generate image-degradation-severity features 316 including classifications of degradations of points of image-feature tensors 306. For example, image 500 may be degraded due to various reasons and sources(such as degradation due to sun glare, water splash, blockage, etc.). To address such scenarios, representation generator 406 may take the degradation type into account. For example, where C_{d}=D and D is a number of pre-defined degradation types.

$${F}_{ID}^{c}$$

is the probability of degradation. In such aspects, W_{ID} is a vector of ones of length D. Alternatively, W_{ID} may be a learnable weight matrix.

After determining the weights of each region, representation generator 406 may perform element-wise multiplication to combine the image features and the weighted degradation features:

$${F}_{im ID aware}^{c} = {F}_{WID}^{c} ⊙ {F}_{im ID aware}^{c} ∈ {R}^{W \times H \times {C}_{i}}$$

where c represents cameras {0, 1, . . . , n}, n represents a number of images from which images are obtained, W represents a width of the images, H represents a height of the images, and Cᵢ represents a number of channels of image data.

Further, representation generator 406 may aggregate and/or project the weighted image-degradation tensors 404 to generate a representation of the environment (e.g., a BEV feature map). For example, representation generator 406 may map the 2D image features (of image-degradation tensors 404) to their corresponding locations in the BEV space (e.g., of features 408). Mapping the 2D image features may involve lifting the features into a 3D space and then projecting the features into a 2D BEV map. Alternatively, mapping the 2D image features may involve directly mapping (e.g., pulling) the image features based on the perspective of the cameras that captured the images.

In some aspects, representation generator 406 may generate features 408 based on degradation types. For example, ID awareness may be propagated to the BEV projection and aggregation stage. For instance, representation generator 406 may generate features 408 based, at least in part, on identifiers (IDs) of degradations. To make the projection step image-degradation aware, representation generator 406 may incorporate the degradation information into the projection process itself. This ensures that the degradation effects are considered not only during camera-wise features aggregations but also during the transformation into the BEV space and subsequent aggregation.

There are several approaches to BEV projections and view transforms. Such approaches include “Lifting Methods” which involve transforming 2D image features into 3D space (creating 3D pillars) and then projecting these 3D features into the BEV space. Such approaches also include “Pulling Methods” which involve directly mapping 2D image features to their corresponding locations in the BEV space based on the camera's perspective. There are other approaches as well. ID awareness is applicable to the other approaches as well.

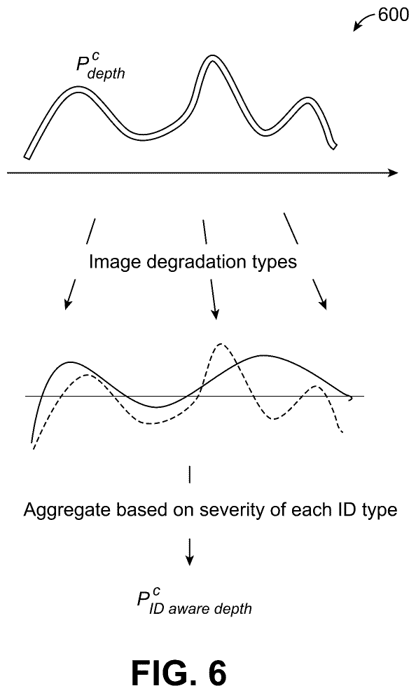

As an example, FIG. 6 is a diagram illustrating a process 600 of processing depth data based on degradation type, according to various aspects of the present disclosure. Process 600 may involve an ID-aware BEV projection. Process 600 may be an implementation of a lifting method. Process 600 may involve a degradation-aware depth adjustment.

For example, lifting methods use depth estimations (e.g., depth values for various points of image-degradation tensors 404). Representation generator 406 may apply ID-awareness to cause the BEV projection to be aware of IDs of degradations by modifying the uncertainty of the depth estimation based on the degradation IDs. This may be done in a learnable way to cause the increase of uncertainty to be kept in line with the inherent uncertainty for a depth estimation network.

For instance, representation generator 406 may compute a depth probability volume. The depth-probability volume may remain in the logits domain for reasons of complexity. For example, representation generator 406 may determine:

$${P}_{depth}^{c} ∈ {R}^{W \times H \times D}$$

where W represents a width of the images, H represents a height of the images, and D represents a number of discrete depth steps that is modeled. For example, if the depth representation represents the range 0-100 m in 2 m discrete steps, D=50.

Representation generator 406 may adjust the depth probability volume using the degradation features, increasing the uncertainty in the depth estimation when the degradation is high (values closer to 1) and decreases it when the degradation is low (values closer to 0).

Certain degradation types affect the uncertainty differently and thus the weighting is advantageously segregated by degradation type. For example, a blockage may affect depth in a different way than fog. While a blocked image tile may totally lose depth precision and the adjusted probability will be spread out, fog degrades depth estimation differently at short and long distances.

Representation generator 406 may determine:

$${P}_{ID aware depth}^{c} = F ( {P}_{depth}^{c} , {F}_{ID}^{c} )$$

where F is a learnable mapping.

For example, representation generator 406 may determine:

$${P}_{ID aware depth}^{c} = {P}_{depth}^{c} + F ( {F}_{ID}^{c} )$$

where F is a learnable mapping.

Adding a bias to the logits is a simple yet effective way to adjust the confidence of the predictions based on degradation features. For example, representation generator 406 may include a learnable linear layer plus a rectified linear unit (ReLU) plus a linear shallow network to determine representation generator 406 based on image-feature tensors 402 and image-degradation tensors 404, where image-degradation tensors 404 includes degradation IDs.

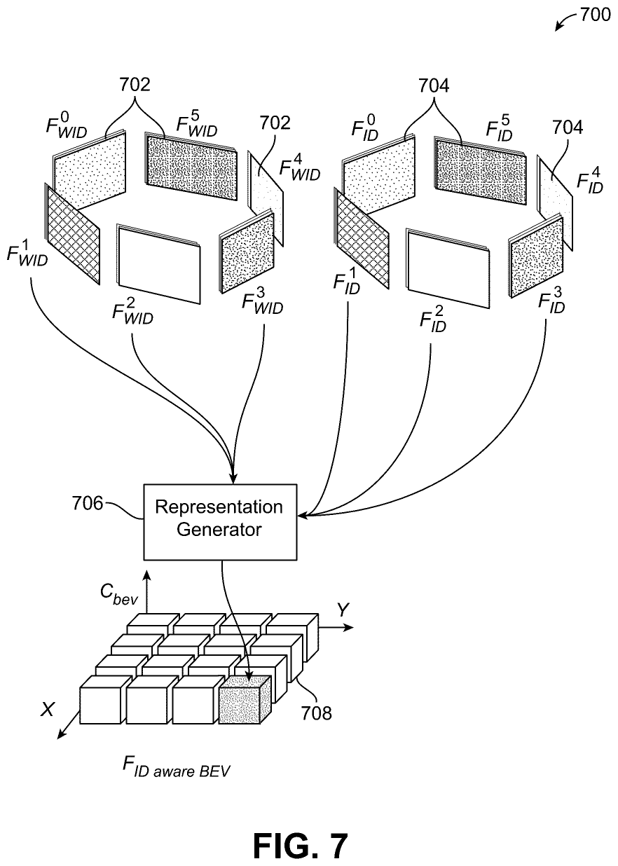

FIG. 7 is a diagram illustrating an example system 700 for generating a representation (e.g., a BEV feature map) of an environment (e.g., of a vehicle) based on image features and image-degradation features, according to various aspects of the present disclosure. System 700 may involve an ID-aware BEV projection system 700 may be an implementation of a pulling method.

Image-feature tensors 702 may be, or may include, weighted image features. Each of image-feature tensors 702 may be weighted based on itself and/or a camera that captured the image on which it was based. For example, image-feature tensors 702 may be weighted in an intra-camera fashion.

System 700 may determine inter-camera attention weights based on image-degradation tensors 704. For example, system 700 may determine weights of image-degradation tensors 704 based on a relationship between each of image-degradation tensors 704 to the others of image-degradation tensors 704.

Representation generator 706 may pull image-feature tensors 702 from 2D to 3D to generate features 708. Additionally, representation generator 706 may perform a vertical dimension reduction (e.g., to flatten the 3D features to a BEV space).

Whether the various camera features are already weighted based on image degradation or not, adaptively aggregating the features based on images from different cameras can provide additional robustness. This approach involves fine-grained, refined weighting where inter-camera views are adaptively aggregated, while the initial feature weighting is performed intra-camera.

Adaptive aggregation allows for dynamic adjustment of feature importance based on the current context and quality of the input. This means that even if initial weights are applied, when features appear in overlapping regions from various views, the aggregation process may re-evaluate the relative strengths and types of image degradation (ID) in the overlapping fields of view (FoV).

By using a camera-based attention mechanism during the BEV projection step, the BEV-based network can dynamically adjust the importance of features from different cameras, focusing on those from the least degraded views. This trainable mechanism allows for a flexible definition of “least degraded” based on the supervising task-specific heads, ensuring robust and accurate BEV features.

Representation generator 706 may compute attention weights for each camera's features based on the degradation features. For each BEV cell, representation generator 706 may aggregate the features from overlapping camera views using the attention weights.

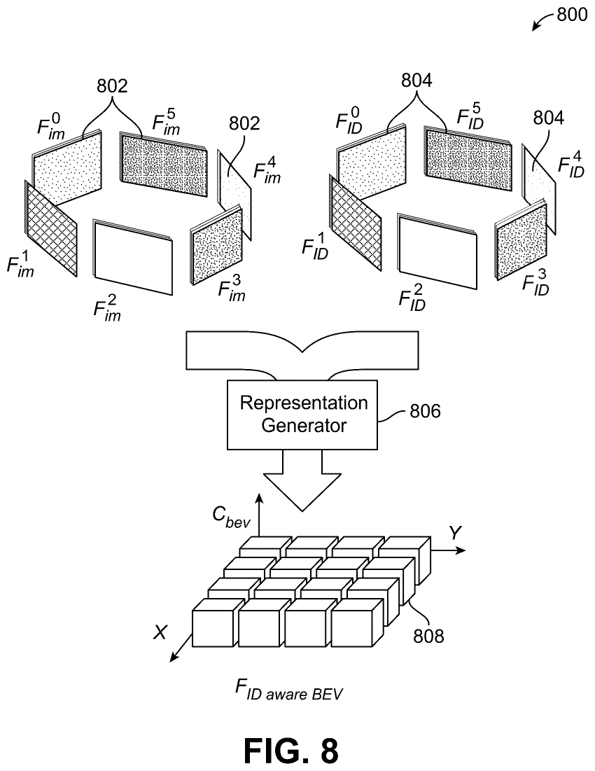

FIG. 8 is a diagram illustrating an example system 800 for generating a representation (e.g., a BEV feature map) of an environment (e.g., of a vehicle) based on image features and image-degradation features, according to various aspects of the present disclosure. Image-feature tensors 802 may be an example of image-feature tensors 402 of FIG. 4. Image-degradation tensors 804 may be an example of image-degradation tensors 404 of FIG. 4. Representation generator 806 may be an example of representation generator 406 of FIG. 4. Features 808 may be an example of features 408 of FIG. 4.

The description of system 400 of FIG. 4 is based on an assumption that the degradation is of an unknown type which is predicted by an “image degradation head” (e.g., degradation encoder(s) 310 and severity encoder(s) 314). In some cases, the degradation type may be known. For example, the degradation type may be determined using some other means of identification. One example is dead pixels in a camera sensor which can be identified through camera diagnostics.

In such a case the known degradation can also be used to weight perspective view features using the proposed invention. Thus, in this example, image features from an area affected by dead pixels will get a lower contribution to the aggregated BEV features. For example, image-degradation tensors 804 may be, or may include, a known degradation mask.

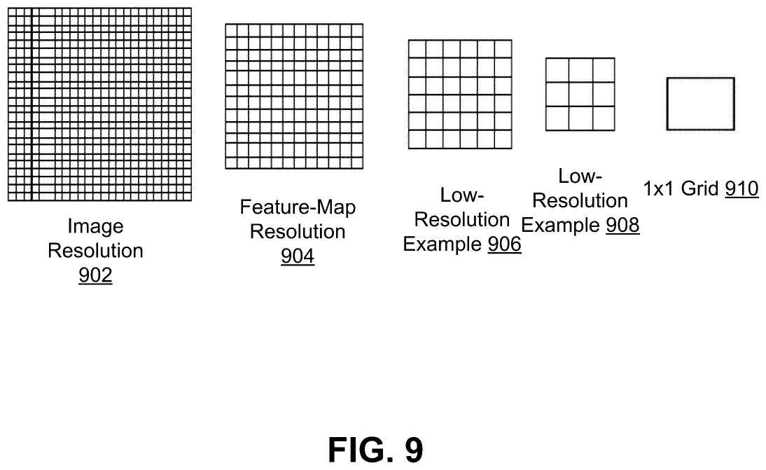

FIG. 9 includes representations of various resolutions to provide context for a description of operating and/or training various elements of system 300 of FIG. 3, according to various aspects of the present disclosure. The degradation encoders (e.g., degradation encoder(s) 310 and/or severity encoder(s) 314) can operate according to various resolutions. Additionally or alternatively, the features (e.g., image-degradation tensors 312) and/or mask output (e.g., image-degradation-severity features 316) can be generated in various resolutions. For example, degradation encoder(s) 310 and severity encoder(s) 314 may generate image-degradation-severity features 316 as a dense mask in the same scale as the image feature map (e.g., image-feature tensors 306).

It is also possible to estimate (and supervise) the degradation in another resolution or shape than the scale of the feature map. For example, image-feature tensors 306 may have a resolution represented by image resolution 902. Degradation encoder(s) 310 may generate image-degradation tensors 312 with a smaller resolution (e.g., represented by feature-map resolution 904). Similarly, severity encoder(s) 314 may generate image-degradation-severity features 316 with a smaller resolution.

The range of possible resolutions may include the resolution of the input image, to any low-resolution grid (e.g., low-resolution example 906 or low-resolution example 908) (to the extreme of a 1×1 grid 910). The grid can also be asymmetric, (e.g. 2×3 or 20×30). If the degradation is expressed in a different resolution the image degradation neck (e.g., degradation encoder(s) 310) and head (e.g., severity encoder(s) 314) the resolution may be adapted as well as the feature weighting (e.g., in representation generator 318). Here the extreme case of a 1×1 grid 910 means that degradation is assessed per camera and in that case feature weighting is done per camera (e.g., by representation generator 318).

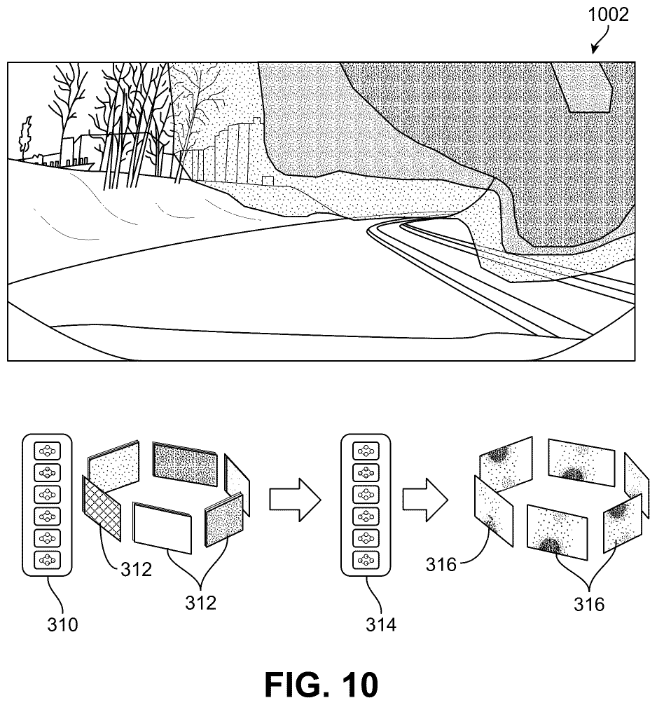

FIG. 10 includes an example segmented image 1002 and elements of system 300 of FIG. 3 to provide context for a description training encoders of system 300 using segmented images, according to various aspects of the present disclosure. In some aspects, degradation encoder(s) 310 and/or severity encoder(s) 314 may be trained. For example, severity encoder(s) 314 may be trained using through a semantic-segmentation supervision in the image plane. The ground truth used is typically a manually annotated semantic segmentation representation of the image degradation. In some aspects, the ground truth, and thus the supervision, can be represented in different resolutions (e.g., as described with regards to FIG. 9). The resolutions may be determined based on trade-offs in performance/robustness/compute efficiency etc. The degradation encoder(s) 310 may be learned implicitly through the image plane image degradation supervision outlined above.

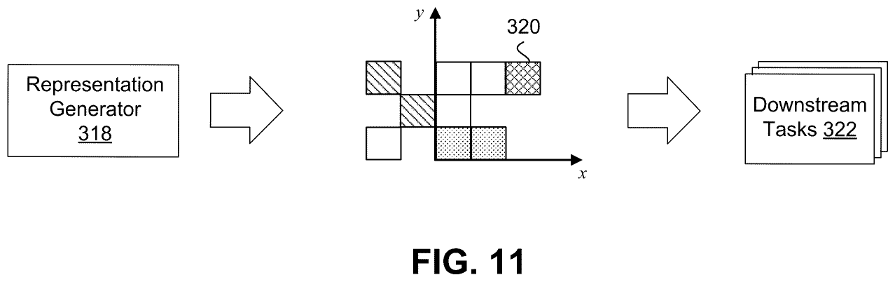

FIG. 11 includes elements of system 300 of FIG. 3 to provide context for a description of training a representation generator of system 300, according to various aspects of the present disclosure. Weights in representation generator 318 may be trained in the following way. The weights in representation generator 318 may be trained by supervision of application-specific heads of downstream tasks 322. For example, the ground truth used is task specific for the tasks in the application-specific heads of downstream tasks 322. Typical tasks in downstream tasks 322 may be, or may include, vehicle detection, pedestrian detection, lane detection, motion planning and control (e.g., steering, braking, accelerating, etc.) control of headlights (e.g., turning on or off headlights or high beams), etc. Beneficially, the weights of representation generator 318 may be trained in a multi-task training scheme using ground truth from several different application-specific heads with corresponding ground truth.

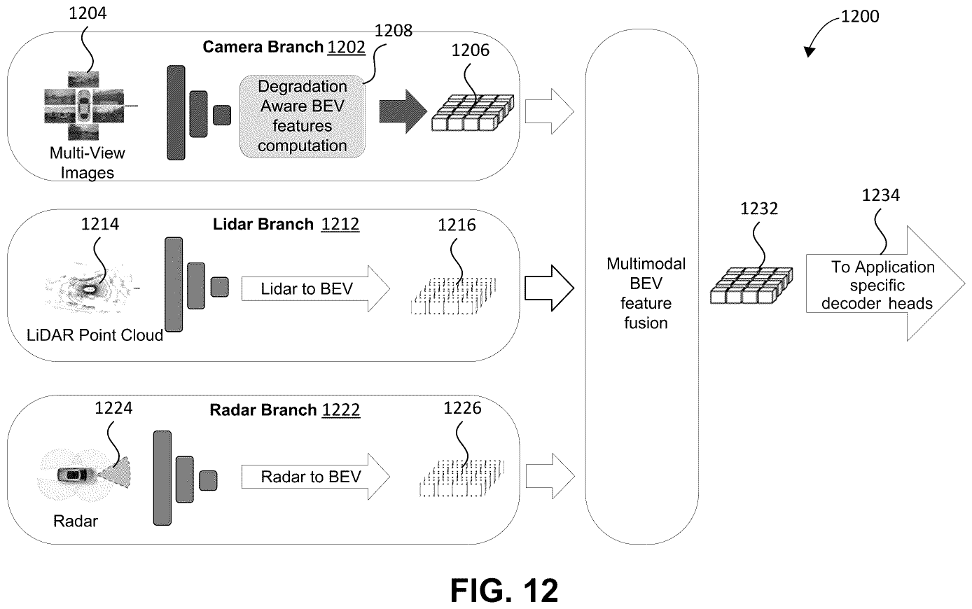

FIG. 12 is a block diagram of an example system 1200 for perception, according to various aspects of the present disclosure. System 1200 includes an example camera branch 1202 that may generate image features 1206 based on image data 1204. In some aspects, system 1200 may include an example LIDAR branch 1212 that may generate LIDAR features 1216 based on LIDAR point cloud 1214. Additionally or alternatively, system 1200 may include an example RADAR branch 1222 that may generate RADAR features 1226 based on RADAR data 1224.

System 1200 may generate BEV features 1232 based on image features 1206 and LIDAR features 1216 and/or RADAR features 1226. System 1200 may provide BEV features 1232 to decoder heads 1234. Decoder heads 1234 may include one or more decoders that are trained to decode BEV features for specific tasks, such as object detection.

System 1200 includes degradation-aware feature computation 1208. Degradation-aware feature computation 1208 may be an example of system 300 of FIG. 3. For example, degradation-aware feature computation 1208 may generate image features 1206 based on image degradation (e.g., of image data 1204). System 1200 is an example of integrating system 300 into a multimodal BEV approach. Degradation-aware feature computation is performed (e.g., by degradation-aware feature computation 1208) prior to multimodal fusion of image features 1306 with LIDAR features 1316 and/or RADAR features 1326.

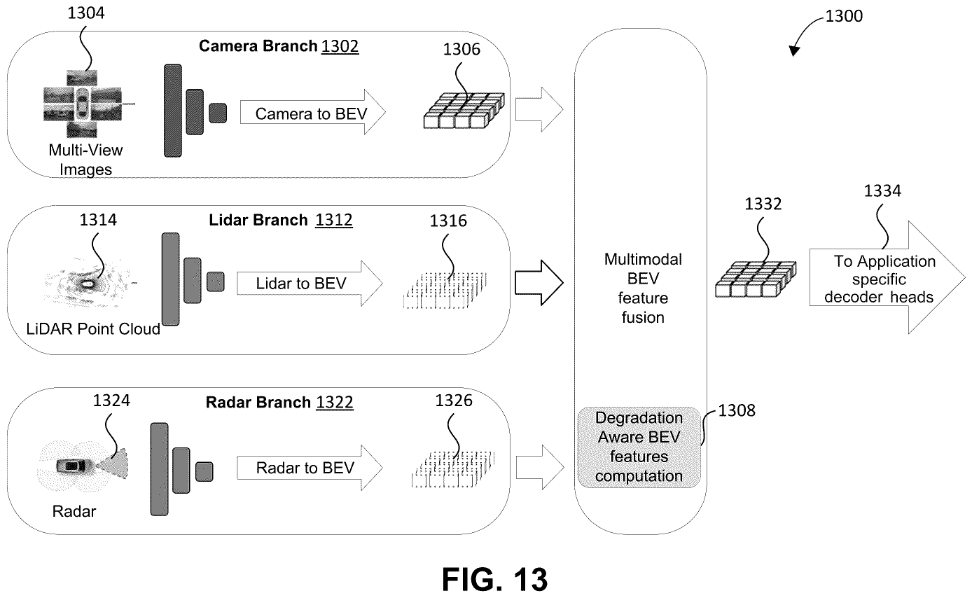

FIG. 13 is a block diagram of an example system 1300 for perception, according to various aspects of the present disclosure. System 1300 includes an example camera branch 1302 that may generate image features 1306 based on image data 1304. In some aspects, system 1300 may include an example LIDAR branch 1312 that may generate LIDAR features 1316 based on LIDAR point cloud 1314. Additionally or alternatively, system 1300 may include an example RADAR branch 1322 that may generate RADAR features 1326 based on RADAR data 1324.

System 1300 may generate BEV features 1332 based on image features 1306 and LIDAR features 1316 and/or RADAR features 1326. System 1300 may provide BEV features 1332 to decoder heads 1334. Decoder heads 1334 may include one or more decoders that are trained to decode BEV features for specific tasks, such as object detection.

System 1300 includes degradation-aware feature computation 1308. Degradation-aware feature computation 1308 may be an example of system 300 of FIG. 3. Degradation-aware feature computation 1308 may fuse image features 1306 with LIDAR features 1316 and/or RADAR features 1326 based on degradation (e.g., of image data 1304). System 1300 is an example of integrating system 300 into a multimodal BEV approach. Degradation-aware feature computation is performed (e.g., by degradation-aware feature computation 1308) as part of multimodal fusion of image features 1306 with LIDAR features 1316 and/or RADAR features 1326.

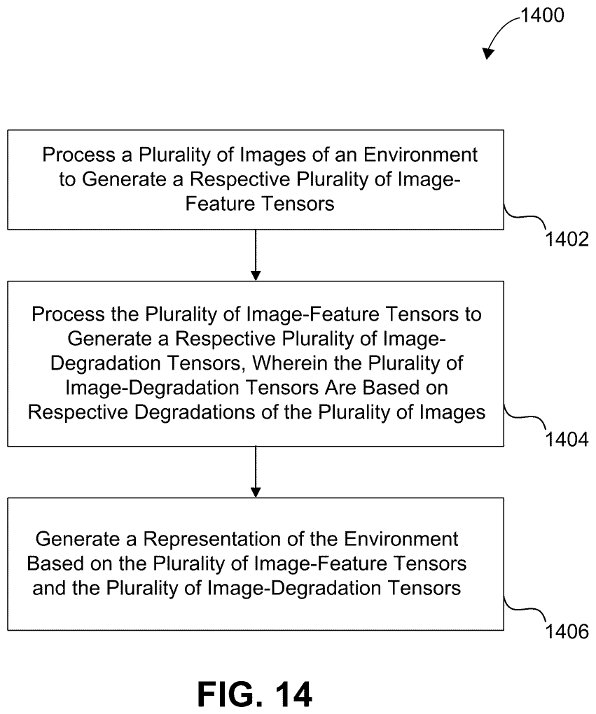

FIG. 14 is a flow diagram illustrating an example process 1400 for generating a representation of an environment, in accordance with aspects of the present disclosure. One or more operations of process 1400 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1400. The one or more operations of process 1400 may be implemented as software components that are executed and run on one or more processors.

At block 1402, a computing device (or one or more components thereof) may process a plurality of images of the environment to generate a respective plurality of image-feature tensors. For example, system 300 may obtain images 302, which may include images captured of an environment from different cameras (e.g., image sensors 104a to 104f). Encoder(s) 304 may process images 302 to generate image-feature tensors 306.

At block 1404, the computing device (or one or more components thereof) may process the plurality of image-feature tensors to generate a respective plurality of image-degradation tensors, wherein the plurality of image-degradation tensors are based on respective degradation levels of the plurality of images. For example, encoder(s) 310 may generate image-degradation tensors 312 based on image-feature tensors 306. Image-degradation tensors 312 may be based on image degradation of images 302.

At block 1406, the computing device (or one or more components thereof) may generate the representation of the environment based on the plurality of image-feature tensors and the plurality of image-degradation tensors. For example, representation generator 318 may generate features 320 based on image-feature tensors 306 and image-degradation tensors 312.

In some aspects, to generate the representation of the environment, the computing device (or one or more components thereof) may: weight values of the plurality of image-feature tensors based on corresponding values of the plurality of image-degradation tensors; and determine values of the representation based on weighted values of the plurality of image-feature tensors. For example, representation generator 318 may weight values of image-feature tensors 306 based on corresponding values of image-degradation tensors 312. Further, representation generator 318 may generate values of features 320 based on the weighted values of image-feature tensors 306.

In some aspects, to determine the values of the representation based on the values of the plurality of image-feature tensors, the computing device (or one or more components thereof) may project the values of the plurality of image-feature tensors to determine the values of the representation. For example, representation generator 318 may project values of image-feature tensors 306 (e.g., as weighted by image-degradation tensors 312) into features 320 (e.g., into a 3D representation of the environment).

In some aspects, to determine the values of the representation based on the values of the plurality of image-feature tensors, the computing device (or one or more components thereof) may pull values of the representation based on the values of the plurality of image-feature tensors. For example, representation generator 318 may pull values of features 320 from image-feature tensors 306 (e.g., as weighted by image-degradation tensors 312).

In some aspects, to generate the representation of the environment, the computing device (or one or more components thereof) may determine values of the representation based on values of the plurality of image-feature tensors and corresponding values of the plurality of image-degradation tensors. For example, representation generator 318 may generate values of features 320 based on values of image-feature tensors 306 and corresponding values of image-degradation tensors 312.

In some aspects, to process the plurality of image-feature tensors to generate the respective plurality of image-degradation tensors, the computing device (or one or more components thereof) may classify degradations of the plurality of images; and the plurality of image-degradation tensors include values based on classifications of the degradations. For example, severity encoder(s) 314 may generate image-degradation-severity features 316 including classifications of degradations of points of image-feature tensors 306. For example, image 500 may be degraded due to various reasons and sources(such as degradation due to sun glare, water splash, blockage, etc.). Image-degradation-severity features 316 may include information about the classification of the image degradation. In such aspects, representation generator 318 may generate features 320 based on image-degradation-severity features 316 and image-degradation tensors 312.

In some aspects, to process the plurality of image-feature tensors to generate the respective plurality of image-degradation tensors, the computing device (or one or more components thereof) may determine magnitudes of degradations of the plurality of images; and the plurality of image-degradation tensors include values based on magnitudes of the degradations. For example, severity encoder(s) 314 may generate image-degradation-severity features 316 including magnitudes of degradations of points of image-feature tensors 306. For example, image 500 may be degraded to various magnitudes (such as 100% degraded, 50% degraded, 0% degraded, etc.). Image-degradation-severity features 316 may include information about the magnitude of the image degradation. In such aspects, representation generator 318 may generate features 320 based on image-degradation-severity features 316 and image-degradation tensors 312.

In some aspects, to process the plurality of image-feature tensors to generate the respective plurality of image-degradation tensors, the computing device (or one or more components thereof) may determine probabilities of degradations of the plurality of images; and the plurality of image-degradation tensors include values based on probabilities of the degradations. For example, severity encoder(s) 314 may generate image-degradation-severity features 316 including probabilities of degradations of points of image-feature tensors 306. For example, image-degradation-severity features 316 may indicate probability determinations regarding degradations (such as 100% certainty regarding degradation, 50% certainty regarding degradation, 0% certainty regarding degradation, etc.). Image-degradation-severity features 316 may include information about the probability of the image degradation. In such aspects, representation generator 318 may generate features 320 based on image-degradation-severity features 316 and image-degradation tensors 312.

In some aspects, the computing device (or one or more components thereof) may at least one of: output an indication of image degradation; detect objects in the environment based on the representation of the environment; display a visual representation of the environment based on the representation of the environment; or adjust an operating parameter of a vehicle based on the representation of the environment. For example, system 300 may output an indication of degradation of any or all of image-feature tensors 306 (e.g., such that a user may clean a camera). As another example, downstream tasks 322 may detect objects based on features 320. As another example, downstream tasks 322 may display a visual representation of the environment based on features 320. As another example, downstream tasks 322 may adjust an operating parameter of a vehicle based on features 320.

In some aspects, the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, a headlight parameter of the vehicle; or displaying information related to the representation of the environment using a user interface of the vehicle.

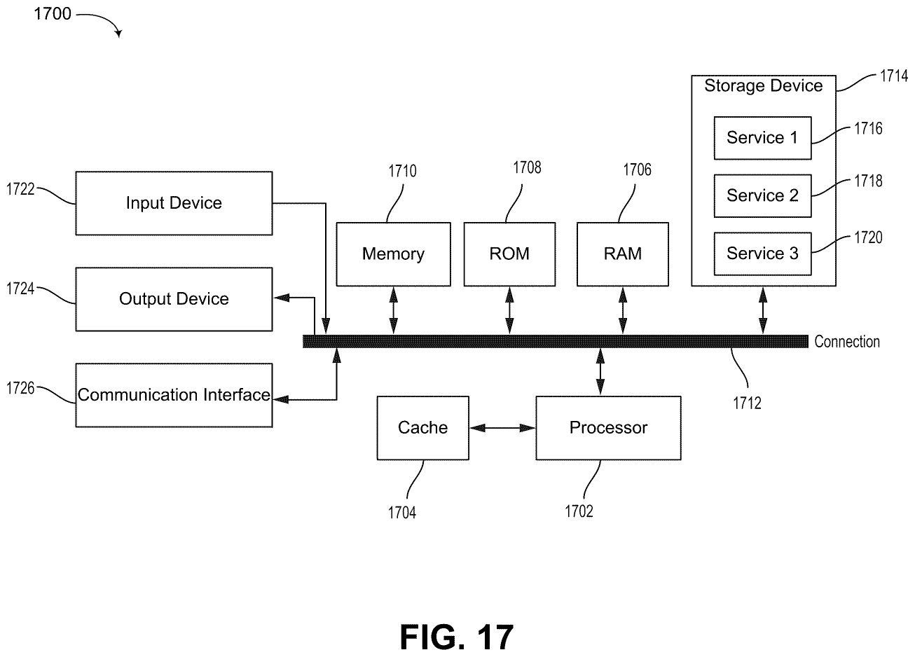

In some examples, as noted previously, the methods described herein (e.g., process 600 of FIG. 6, process 1400 of FIG. 14, and/or other methods described herein) can be performed, in whole or in part, by a computing device or apparatus. In one example, one or more of the methods can be performed by a computing system of vehicle 102 of FIG. 1, system 300 of FIG. 3, system 400 FIG. 4, system 700 of FIG. 7, system 800 of FIG. 8, or by another system or device. In another example, one or more of the methods (e.g., process 1400, and/or other methods described herein) can be performed, in whole or in part, by the computing-device architecture 1700 shown in FIG. 17. For instance, a computing device with the computing-device architecture 1700 shown in FIG. 17 can include, or be included in, the components of the computing system of vehicle 102 of FIG. 1, system 300 of FIG. 3, system 400 FIG. 4, system 700 of FIG. 7, system 800 of FIG. 8 and can implement the operations of process 600, process 1400, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 600, process 1400, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 600 process 1400, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

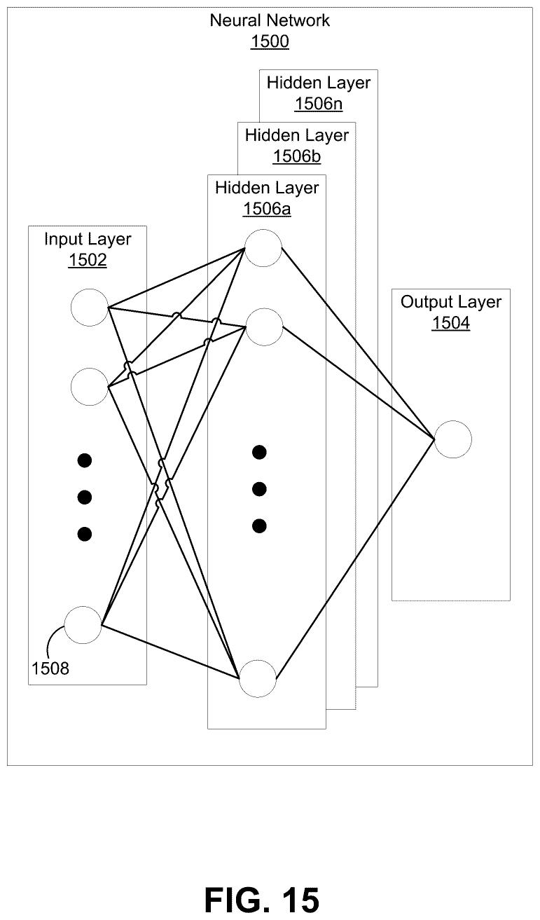

FIG. 15 is an illustrative example of a neural network 1500 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 1500 may be an example of, or can implement, feature encoder(s) 304, feature encoder(s) 308, degradation encoder(s) 310, severity encoder(s) 314, and/or representation generator 318 of FIG. 3, FIG. 10, and FIG. 11, representation generator 406 of FIG. 4, representation generator 706 of FIG. 7, and/or representation generator 806 of FIG. 8.

An input layer 1502 includes input data. In one illustrative example, input layer 1502 can include data representing images 302, image-feature tensors 306, image-degradation tensors 312, and/or image-degradation-severity features 316 of FIG. 3, image-feature tensors 402 and image-degradation tensors 404 of FIG. 4, image-feature tensors 702 and image-degradation tensors 704 of FIG. 7, and/or image-feature tensors 802 and image-degradation tensors 804 of FIG. 8. Neural network 1500 includes multiple hidden layers, for example, hidden layers 1506a, 1506b, through 1506n. The hidden layers 1506a, 1506b, through hidden layer 1506n include “n” number of hidden layers, where “n” is an integer greater than or equal to one. The number of hidden layers can be made to include as many layers as needed for the given application. Neural network 1500 further includes an output layer 1504 that provides an output resulting from the processing performed by the hidden layers 1506a, 1506b, through 1506n. In one illustrative example, output layer 1504 can generate image-feature tensors 306, image-degradation tensors 312, image-degradation-severity features 316, and/or features 320 of FIG. 3, features 408 of FIG. 4, features 708 of FIG. 7, and/or features 808 of FIG. 8.

Neural network 1500 may be, or may include, a multi-layer neural network of interconnected nodes. Each node can represent a piece of information. Information associated with the nodes is shared among the different layers and each layer retains information as information is processed. In some cases, neural network 1500 can include a feed-forward network, in which case there are no feedback connections where outputs of the network are fed back into itself. In some cases, neural network 1500 can include a recurrent neural network, which can have loops that allow information to be carried across nodes while reading in input.

Information can be exchanged between nodes through node-to-node interconnections between the various layers. Nodes of input layer 1502 can activate a set of nodes in the first hidden layer 1506a. For example, as shown, each of the input nodes of input layer 1502 is connected to each of the nodes of the first hidden layer 1506a. The nodes of first hidden layer 1506a can transform the information of each input node by applying activation functions to the input node information. The information derived from the transformation can then be passed to and can activate the nodes of the next hidden layer 1506b, which can perform their own designated functions. Example functions include convolutional, up-sampling, data transformation, and/or any other suitable functions. The output of the hidden layer 1506b can then activate nodes of the next hidden layer, and so on. The output of the last hidden layer 1506n can activate one or more nodes of the output layer 1504, at which an output is provided. In some cases, while nodes (e.g., node 1508) in neural network 1500 are shown as having multiple output lines, a node has a single output and all lines shown as being output from a node represent the same output value.

In some cases, each node or interconnection between nodes can have a weight that is a set of parameters derived from the training of neural network 1500. Once neural network 1500 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1500 to be adaptive to inputs and able to learn as more and more data is processed.

Neural network 1500 may be pre-trained to process the features from the data in the input layer 1502 using the different hidden layers 1506a, 1506b, through 1506n in order to provide the output through the output layer 1504. In an example in which neural network 1500 is used to identify features in images, neural network 1500 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 1500 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 1500 is trained well enough so that the weights of the layers are accurately tuned.

For the example of identifying objects in images, the forward pass can include passing a training image through neural network 1500. The weights are initially randomized before neural network 1500 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1500, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1500 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½ (target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1500 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 1500 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1500 can include any other deep network other than a CNN, such as an autoencoder, a deep belief nets (DBNs), a Recurrent Neural Networks (RNNs), among others.

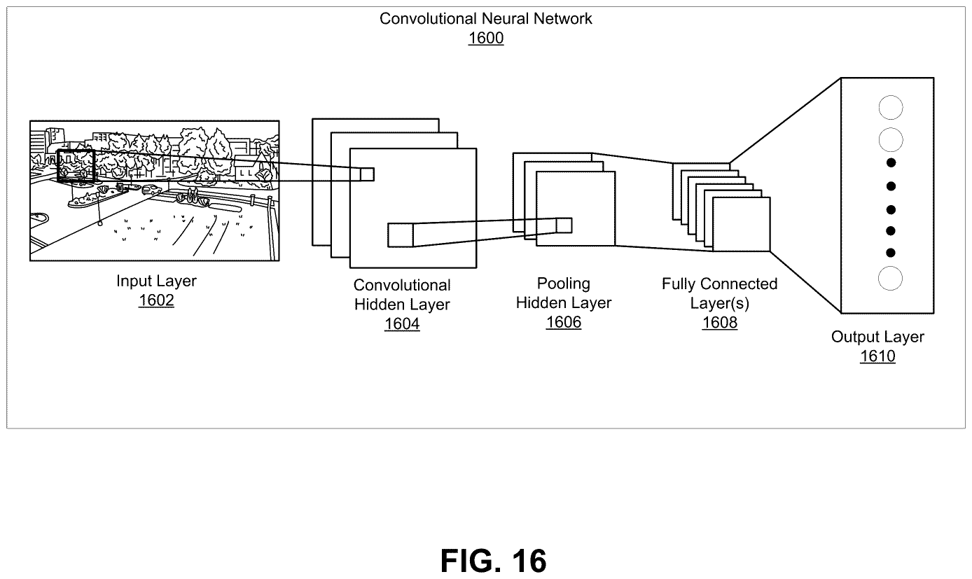

FIG. 16 is an illustrative example of a convolutional neural network (CNN) 1600. The input layer 1602 of the CNN 1600 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1604, an optional non-linear activation layer, a pooling hidden layer 1606, and fully connected layer 1608 (which fully connected layer 1608 can be hidden) to get an output at the output layer 1610. While only one of each hidden layer is shown in FIG. 16, one of ordinary skill will appreciate that multiple convolutional hidden layers, non-linear layers, pooling hidden layers, and/or fully connected layers can be included in the CNN 1600. As previously described, the output can indicate a single class of an object or can include a probability of classes that best describe the object in the image.

The first layer of the CNN 1600 can be the convolutional hidden layer 1604. The convolutional hidden layer 1604 can analyze image data of the input layer 1602. Each node of the convolutional hidden layer 1604 is connected to a region of nodes (pixels) of the input image called a receptive field. The convolutional hidden layer 1604 can be considered as one or more filters (each filter corresponding to a different activation or feature map), with each convolutional iteration of a filter being a node or neuron of the convolutional hidden layer 1604. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1604. Each connection between a node and a receptive field for that node learns a weight and, in some cases, an overall bias such that each node learns to analyze its particular local receptive field in the input image. Each node of the convolutional hidden layer 1604 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1604 is due to each node of the convolutional layer being applied to its corresponding receptive field. For example, a filter of the convolutional hidden layer 1604 can begin in the top-left corner of the input image array and can convolve around the input image. As noted above, each convolutional iteration of the filter can be considered a node or neuron of the convolutional hidden layer 1604. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1604. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1604.

The mapping from the input layer to the convolutional hidden layer 1604 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1604 can include several activation maps in order to identify multiple features in an image. The example shown in FIG. 16 includes three activation maps. Using three activation maps, the convolutional hidden layer 1604 can detect three different kinds of features, with each feature being detectable across the entire image.

In some examples, a non-linear hidden layer can be applied after the convolutional hidden layer 1604. The non-linear layer can be used to introduce non-linearity to a system that has been computing linear operations. One illustrative example of a non-linear layer is a rectified linear unit (ReLU) layer. A ReLU layer can apply the function ƒ(x)=max(0, x) to all of the values in the input volume, which changes all the negative activations to 0. The ReLU can thus increase the non-linear properties of the CNN 1600 without affecting the receptive fields of the convolutional hidden layer 1604.

The pooling hidden layer 1606 can be applied after the convolutional hidden layer 1604 (and after the non-linear hidden layer when used). The pooling hidden layer 1606 is used to simplify the information in the output from the convolutional hidden layer 1604. For example, the pooling hidden layer 1606 can take each activation map output from the convolutional hidden layer 1604 and generates a condensed activation map (or feature map) using a pooling function. Max-pooling is one example of a function performed by a pooling hidden layer. Other forms of pooling functions be used by the pooling hidden layer 1606, such as average pooling, L2-norm pooling, or other suitable pooling functions. A pooling function (e.g., a max-pooling filter, an L2-norm filter, or other suitable pooling filter) is applied to each activation map included in the convolutional hidden layer 1604. In the example shown in FIG. 16, three pooling filters are used for the three activation maps in the convolutional hidden layer 1604.

In some examples, max-pooling can be used by applying a max-pooling filter (e.g., having a size of 2×2) with a stride (e.g., equal to a dimension of the filter, such as a stride of 2) to an activation map output from the convolutional hidden layer 1604. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1604 having a dimension of 24×24 nodes, the output from the pooling hidden layer 1606 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1600.

The final layer of connections in the network is a fully-connected layer that connects every node from the pooling hidden layer 1606 to every one of the output nodes in the output layer 1610. Using the example above, the input layer includes 28×28 nodes encoding the pixel intensities of the input image, the convolutional hidden layer 1604 includes 3×24×24 hidden feature nodes based on application of a 5×5 local receptive field (for the filters) to three activation maps, and the pooling hidden layer 1606 includes a layer of 3×12×12 hidden feature nodes based on application of max-pooling filter to 2×2 regions across each of the three feature maps. Extending this example, the output layer 1610 can include ten output nodes. In such an example, every node of the 3×12×12 pooling hidden layer 1606 is connected to every node of the output layer 1610.

The fully connected layer 1608 can obtain the output of the previous pooling hidden layer 1606 (which should represent the activation maps of high-level features) and determines the features that most correlate to a particular class. For example, the fully connected layer 1608 can determine the high-level features that most strongly correlate to a particular class and can include weights (nodes) for the high-level features. A product can be computed between the weights of the fully connected layer 1608 and the pooling hidden layer 1606 to obtain probabilities for the different classes. For example, if the CNN 1600 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1610 can include an M-dimensional vector (in the prior example, M=10). M indicates the number of classes that the CNN 1600 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 17 illustrates an example computing-device architecture 1700 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1700 may include, implement, or be included in any or all of computing system of vehicle 102 of FIG. 1, system 300 of FIG. 3, system 400 FIG. 4, system 700 of FIG. 7, system 800 of FIG. 8 and/or other devices, modules, or systems described herein. Additionally or alternatively, computing-device architecture 1700 may be configured to perform process 600, process 1400, and/or other process described herein.

The components of computing-device architecture 1700 are shown in electrical communication with each other using connection 1712, such as a bus. The example computing-device architecture 1700 includes a processing unit (CPU or processor) 1702 and computing device connection 1712 that couples various computing device components including computing device memory 1710, such as read only memory (ROM) 1708 and random-access memory (RAM) 1706, to processor 1702.

Computing-device architecture 1700 can include a cache of high-speed memory connected directly with, in close proximity to, or integrated as part of processor 1702. Computing-device architecture 1700 can copy data from memory 1710 and/or the storage device 1714 to cache 1704 for quick access by processor 1702. In this way, the cache can provide a performance boost that avoids processor 1702 delays while waiting for data. These and other modules can control or be configured to control processor 1702 to perform various actions. Other computing device memory 1710 may be available for use as well. Memory 1710 can include multiple different types of memory with different performance characteristics. Processor 1702 can include any general-purpose processor and a hardware or software service, such as service 1 1716, service 2 1718, and service 3 1720 stored in storage device 1714, configured to control processor 1702 as well as a special-purpose processor where software instructions are incorporated into the processor design. Processor 1702 may be a self-contained system, containing multiple cores or processors, a bus, memory controller, cache, etc. A multi-core processor may be symmetric or asymmetric.

To enable user interaction with the computing-device architecture 1700, input device 1722 can represent any number of input mechanisms, such as a microphone for speech, a touch-sensitive screen for gesture or graphical input, keyboard, mouse, motion input, speech and so forth. Output device 1724 can also be one or more of a number of output mechanisms known to those of skill in the art, such as a display, projector, television, speaker device, etc. In some instances, multimodal computing devices can enable a user to provide multiple types of input to communicate with computing-device architecture 1700. Communication interface 1726 can generally govern and manage the user input and computing device output. There is no restriction on operating on any particular hardware arrangement and therefore the basic features here may easily be substituted for improved hardware or firmware arrangements as they are developed.

Storage device 1714 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1706, read only memory (ROM) 1708, and hybrids thereof. Storage device 1714 can include services 1716, 1718, and 1720 for controlling processor 1702. Other hardware or software modules are contemplated. Storage device 1714 can be connected to the computing device connection 1712. In one aspect, a hardware module that performs a particular function can include the software component stored in a computer-readable medium in connection with the necessary hardware components, such as processor 1702, connection 1712, output device 1724, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for generating a representation of an environment, the apparatus comprising: at least one memory; and at least one processor coupled to the at least one memory and configured to: process a plurality of images of the environment to generate a respective plurality of image-feature tensors; process the plurality of image-feature tensors to generate a respective plurality of image-degradation tensors, wherein the plurality of image-degradation tensors are based on respective degradation levels of the plurality of images; and generate the representation of the environment based on the plurality of image-feature tensors and the plurality of image-degradation tensors.
Aspect 2. The apparatus of aspect 1, wherein the at least one processor is configured to at least one of: output an indication of image degradation; detect objects in the environment based on the representation of the environment; display a visual representation of the environment based on the representation of the environment; or adjust an operating parameter of a vehicle based on the representation of the environment.
Aspect 3. The apparatus of aspect 2, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, a headlight parameter of the vehicle; or displaying information related to the representation of the environment using a user interface of the vehicle.
Aspect 4. The apparatus of any one of aspects 1 to 3, wherein, to generate the representation of the environment, the at least one processor is configured to: weight values of the plurality of image-feature tensors based on corresponding values of the plurality of image-degradation tensors; and determine values of the representation based on weighted values of the plurality of image-feature tensors.
Aspect 5. The apparatus of aspect 4, wherein, to determine the values of the representation based on the values of the plurality of image-feature tensors, the at least one processor is configured to project the values of the plurality of image-feature tensors to determine the values of the representation.
Aspect 6. The apparatus of any one of aspects 4 or 5, wherein, to determine the values of the representation based on the values of the plurality of image-feature tensors, the at least one processor is configured to pull values of the representation based on the values of the plurality of image-feature tensors.
Aspect 7. The apparatus of any one of aspects 1 to 6, wherein, to generate the representation of the environment, the at least one processor is configured to determine values of the representation based on values of the plurality of image-feature tensors and corresponding values of the plurality of image-degradation tensors.
Aspect 8. The apparatus of any one of aspects 1 to 7, wherein: to process the plurality of image-feature tensors to generate the respective plurality of image-degradation tensors, the at least one processor is configured to classify degradations of the plurality of images; and the plurality of image-degradation tensors include values based on classifications of the degradations.
Aspect 9. The apparatus of any one of aspects 1 to 8, wherein: to process the plurality of image-feature tensors to generate the respective plurality of image-degradation tensors, the at least one processor is configured to determine magnitudes of degradations of the plurality of images; and the plurality of image-degradation tensors include values based on magnitudes of the degradations.
Aspect 10. The apparatus of any one of aspects 1 to 9, wherein: to process the plurality of image-feature tensors to generate the respective plurality of image-degradation tensors, the at least one processor is configured to determine probabilities of degradations of the plurality of images; and the plurality of image-degradation tensors include values based on probabilities of the degradations.
Aspect 11. The apparatus of any one of aspects 1 to 10, wherein the at least one processor is configured to adjust an operating parameter of a vehicle based on the representation of the environment.
Aspect 12. The apparatus of aspect 11, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, a headlight parameter of the vehicle, displaying information related to the representation of the environment using a user interface of the vehicle, displaying an indication regarding image degradation using the user interface of the vehicle.
Aspect 13. A method for generating a representation of an environment, the method comprising: processing a plurality of images of the environment to generate a respective plurality of image-feature tensors; processing the plurality of image-feature tensors to generate a respective plurality of image-degradation tensors, wherein the plurality of image-degradation tensors are based on respective degradation levels of the plurality of images; and generating the representation of the environment based on the plurality of image-feature tensors and the plurality of image-degradation tensors.
Aspect 14. The method of aspect 13, further comprising at least one of: outputting an indication of image degradation; detecting objects in the environment based on the representation of the environment; displaying a visual representation of the environment based on the representation of the environment; or adjusting an operating parameter of a vehicle based on the representation of the environment.
Aspect 15. The method of aspect 14, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, a headlight parameter of the vehicle; or displaying information related to the representation of the environment using a user interface of the vehicle.
Aspect 16. The method of any one of aspects 13 to 15, wherein generating the representation of the environment comprises: weighting values of the plurality of image-feature tensors based on corresponding values of the plurality of image-degradation tensors; and determining values of the representation based on weighted values of the plurality of image-feature tensors.
Aspect 17. The method of aspect 16, wherein determining the values of the representation based on the values of the plurality of image-feature tensors comprises projecting the values of the plurality of image-feature tensors to determine the values of the representation.
Aspect 18. The method of any one of aspects 16 or 17, wherein determining the values of the representation based on the values of the plurality of image-feature tensors comprises pulling values of the representation based on the values of the plurality of image-feature tensors.
Aspect 19. The method of any one of aspects 13 to 18, wherein generating the representation of the environment comprises determining values of the representation based on values of the plurality of image-feature tensors and corresponding values of the plurality of image-degradation tensors.
Aspect 20. The method of any one of aspects 13 to 19, wherein: processing the plurality of image-feature tensors to generate the respective plurality of image-degradation tensors comprises classifying degradations of the plurality of images; and the plurality of image-degradation tensors include values based on classifications of the degradations.
Aspect 21. The method of any one of aspects 13 to 20, wherein: processing the plurality of image-feature tensors to generate the respective plurality of image-degradation tensors comprises determining magnitudes of degradations of the plurality of images; and the plurality of image-degradation tensors include values based on magnitudes of the degradations.
Aspect 22. The method of any one of aspects 13 to 21, wherein: processing the plurality of image-feature tensors to generate the respective plurality of image-degradation tensors comprises determining probabilities of degradations of the plurality of images; and the plurality of image-degradation tensors include values based on probabilities of the degradations.
Aspect 23. The method of any one of aspects 13 to 22, further comprising adjusting an operating parameter of a vehicle based on the representation of the environment.
Aspect 24. The method of aspect 23, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, a headlight parameter of the vehicle, displaying information related to the representation of the environment using a user interface of the vehicle, displaying an indication regarding image degradation using the user interface of the vehicle.
Aspect 25. A non-transitory computer-readable storage medium having stored thereon instructions that, when executed by at least one processor, cause the at least one processor to perform operations according to any of aspects 13 to 24.
Aspect 26. An apparatus for generating a representation of an environment, the apparatus comprising one or more means for perform operations according to any of aspects 13 to 24.

What is claimed is:

1. An apparatus for generating a representation of an environment, the apparatus comprising:
at least one memory; and
at least one processor coupled to the at least one memory and configured to:
process a plurality of images of the environment to generate a respective plurality of image-feature tensors;
process the plurality of image-feature tensors to generate a respective plurality of image-degradation tensors, wherein the plurality of image-degradation tensors are based on respective degradation levels of the plurality of images; and
generate the representation of the environment based on the plurality of image-feature tensors and the plurality of image-degradation tensors.

2. The apparatus of claim 1, wherein the at least one processor is configured to at least one of:
output an indication of image degradation;
detect objects in the environment based on the representation of the environment;
display a visual representation of the environment based on the representation of the environment; or
adjust an operating parameter of a vehicle based on the representation of the environment.

3. The apparatus of claim 2, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, a headlight parameter of the vehicle; or displaying information related to the representation of the environment using a user interface of the vehicle.

4. The apparatus of claim 1, wherein, to generate the representation of the environment, the at least one processor is configured to:
weight values of the plurality of image-feature tensors based on corresponding values of the plurality of image-degradation tensors; and
determine values of the representation based on weighted values of the plurality of image-feature tensors.

5. The apparatus of claim 4, wherein, to determine the values of the representation based on the values of the plurality of image-feature tensors, the at least one processor is configured to project the values of the plurality of image-feature tensors to determine the values of the representation.

6. The apparatus of claim 4, wherein, to determine the values of the representation based on the values of the plurality of image-feature tensors, the at least one processor is configured to pull values of the representation based on the values of the plurality of image-feature tensors.

7. The apparatus of claim 1, wherein, to generate the representation of the environment, the at least one processor is configured to determine values of the representation based on values of the plurality of image-feature tensors and corresponding values of the plurality of image-degradation tensors.

8. The apparatus of claim 1, wherein:
to process the plurality of image-feature tensors to generate the respective plurality of image-degradation tensors, the at least one processor is configured to classify degradations of the plurality of images; and
the plurality of image-degradation tensors include values based on classifications of the degradations.

9. The apparatus of claim 1, wherein:
to process the plurality of image-feature tensors to generate the respective plurality of image-degradation tensors, the at least one processor is configured to determine magnitudes of degradations of the plurality of images; and
the plurality of image-degradation tensors include values based on magnitudes of the degradations.

10. The apparatus of claim 1, wherein:
to process the plurality of image-feature tensors to generate the respective plurality of image-degradation tensors, the at least one processor is configured to determine probabilities of degradations of the plurality of images; and
the plurality of image-degradation tensors include values based on probabilities of the degradations.

11. The apparatus of claim 1, wherein the at least one processor is configured to adjust an operating parameter of a vehicle based on the representation of the environment.

12. The apparatus of claim 11, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, a headlight parameter of the vehicle, displaying information related to the representation of the environment using a user interface of the vehicle, displaying an indication regarding image degradation using the user interface of the vehicle.

13. A method for generating a representation of an environment, the method comprising:
processing a plurality of images of the environment to generate a respective plurality of image-feature tensors;
processing the plurality of image-feature tensors to generate a respective plurality of image-degradation tensors, wherein the plurality of image-degradation tensors are based on respective degradation levels of the plurality of images; and
generating the representation of the environment based on the plurality of image-feature tensors and the plurality of image-degradation tensors.

14. The method of claim 13, further comprising at least one of:
outputting an indication of image degradation;
detecting objects in the environment based on the representation of the environment;
displaying a visual representation of the environment based on the representation of the environment; or
adjusting an operating parameter of a vehicle based on the representation of the environment.

15. The method of claim 14, wherein the operating parameter is associated with at least one of a path for the vehicle to travel, a steering parameter for operating steering of the vehicle, a braking parameter for operating brakes of the vehicle, a lane-change parameter for causing the vehicle to navigate from a first lane to a second lane, a headlight parameter of the vehicle; or displaying information related to the representation of the environment using a user interface of the vehicle.

16. The method of claim 13, wherein generating the representation of the environment comprises:
weighting values of the plurality of image-feature tensors based on corresponding values of the plurality of image-degradation tensors; and
determining values of the representation based on weighted values of the plurality of image-feature tensors.

17. The method of claim 16, wherein determining the values of the representation based on the values of the plurality of image-feature tensors comprises projecting the values of the plurality of image-feature tensors to determine the values of the representation.

18. The method of claim 16, wherein determining the values of the representation based on the values of the plurality of image-feature tensors comprises pulling values of the representation based on the values of the plurality of image-feature tensors.

19. The method of claim 13, wherein generating the representation of the environment comprises determining values of the representation based on values of the plurality of image-feature tensors and corresponding values of the plurality of image-degradation tensors.

20. The method of claim 13, wherein:
processing the plurality of image-feature tensors to generate the respective plurality of image-degradation tensors comprises classifying degradations of the plurality of images; and
the plurality of image-degradation tensors include values based on classifications of the degradations.
